(19) United States
(12) Patent Application Publication
(10) Pub. No.: US 2016/0019779 A1
(43) Pub. Date: Jan. 21, 2016

(54) COMMAND SET SELECTION IN A HANDHELD REMOTE CONTROL

(71) Applicant: Universal Remote Control, Harrison, NY (US)

(72) Inventor: Chang K. Park, Armonk, NY (US)

(21) Appl. No.: 14/334,020

(22) Filed: Jul. 17, 2014

(51) Int. Cl. G08C 17/02

(52) U.S. Cl. CPC G08C 17/02; G08C 2201/20

(57) ABSTRACT

Systems and techniques for command set selection in a handheld remote control are described herein. An initiation input for programming the handheld remote control can be received. A subset of commands sets can be selected with probabilistic ordering and iterated over in response to the initiation input. The iteration can include selecting a next command set from the subset of command sets to be the current command set and testing the current command set. A command set confirmation can be received. In response to the command set confirmation, the iteration can be terminated and the handheld remote control can be programmed with the current command set.

### BACKGROUND

Handheld remote control devices have been used to control consumer electronic devices (e.g., televisions, stereos, video cassette players, disc players, or other entertainment or information devices that are remotely controllable) for some time. Generally, handheld remote control devices include a number of control elements (e.g., buttons, keys, dials, etc.) and a transmitter. When a control element is actuated by a user, a corresponding command is sent via the transmitter to the consumer electronic device. The command causes the consumer electronic device to perform an action. Typically, the control element indicates the desired action. For example, actuating a “power off” control element causes a power-off command to be sent to the consumer electronic device. Example actions can include power (on or off), a change in volume, a change in channel, a number (e.g., for selecting a channel), etc. Not all consumer electronic devices respond to the same command for the same action. For example, a first consumer electronic device and a second consumer electronic device may have different commands for powering on. Generally, a consumer electronic device responds to a particular command set.

Often, consumer electronic device manufacturers will provide consumers (e.g., users) with a handheld remote control device designed to work with the consumer electronic device. That is, the provided handheld remote control device will be configured with a command set compatible with the consumer electronic device. Control elements of the handheld remote control device will correspond to commands in the command set. Under this arrangement, consumers may have several handheld remote control devices to control their entertainment systems. For example, a consumer may have separate handheld remote control devices for each of a television, content provider device (e.g., cable or satellite content provider), disc player, etc.

To reduce the number of handheld remote control devices a user requires to operate their consumer electronic devices, or to replace a lost handheld remote control device, a number of “universal” handheld remote control devices have been produced. Generally, such a handheld remote control device will be provided with several command sets (e.g., a set of command sets). The handheld remote control device will include a technique to select which of the set of command sets should be used to control a given consumer electronic device. This technique is herein referred to as programming the handheld remote control device. Essentially, programming the handheld remote control device involves searching through the command sets available to the handheld remote control device. Traditionally, programming the handheld remote control device included a printed manual of consumer electronic device codes or codes related to consumer electronic devices. The user would enter a programming mode for the handheld remote control device and input a code. Often, a test, such as attempting to power off the consumer electronic device, would be performed to determine if the command set selected by the code input was the correct command set for the consumer electronic device. This process continued until the user discovered the right command set.

Over time, as the number of command sets available to a handheld remote control device grew, a variety of techniques arose to help users program the handheld remote control device. Often, these techniques focused on rearranging the available control element user interface to reduce the number of individual inputs a user would have to perform during the search. For example, the volume up button could be re-tasked to select the next command set and perform the power off function each time it is pressed. Again, generally, these techniques focus on modifying the number and types of control element inputs for a user when working off of the published set of command codes.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a system for command set selection in a handheld remote control, according to an embodiment.

FIG. 2 illustrates an example of components for command set selection in a handheld remote control, according to an embodiment.

FIGS. 3 and 4 illustrate examples of command set selection with probabilistic ordering, according to two embodiments.

FIG. 5 illustrates an example of a method for command set selection in a handheld remote control, according to an embodiment.

FIG. 6 is a block diagram illustrating an example of a machine upon which one or more embodiments may be implemented.

### DETAILED DESCRIPTION

Manipulating the control elements used to program the handheld remote control device can be limiting. First, adding programming specific control elements to the handheld remote control device can increase costs and decrease the usability of the handheld remote control device by cluttering the interface with little used control elements. Second, if a simple control element interface is used, the types and numbers of programming sequences can be limited or involve complex combinations of control element actuation that can be frustrating to users.

Handheld remote control programming can be made more efficient, however, while still maintaining a modest control element interface by adjusting the ordering of the command sets during the programming search activity. That is, if the current command set being tested doesn't work, intelligently choosing the second command set to test will reduce the time spent searching for the correct command set. In an example, a probabilistic ordering can be applied to the available command sets to select a subset of command sets to iterate over for the search. In an example, the members of the subset of command sets can also be ordered using the first probabilistic ordering, or a second probabilistic ordering. Thus, the time spent searching for a command set to operate a given consumer electronic device is likely reduced.

As used herein, probabilistic ordering is an ordering of elements based on a probability of an outcome. In an example, the outcome can be whether the consumer electronic device is responsive to a command set. There can, however, be a variety of bases upon which the probability is determined. For example, consider the probability that the consumer electronic device is responsive to a command set. A basis for determining this probability could be sales figures for consumer electronic devices, or for consumer electronic device brands. Command sets corresponding to consumer electronic devices with higher sales figures can be assigned a higher probability than those corresponding to consumer electronic devices with lower sales figures. Another basis can include the application of sales figures, with the addition of longevity data (e.g., how long people tend to keep/use a consumer electronic device). A modestly selling consumer electronic device with good longevity can be calculated to be more prevalent than a brand with higher sales figures and poor longevity. Thus, the probabilities of command sets corresponding to these consumer electronic devices can be adjusted. Another example basis can include the use of previously known information. For example, if a user selects a first consumer electronic device brand, and the corresponding command sets are unsuccessfully tested, command sets corresponding to a second brand can be tested based on, for example, user confusion between the two brands. This scenario may adjust a previously sales based probabilistic ordering. For example, a third brand may be more popular than the second brand. However, because of the available customer confusion information and knowledge of the previous customer consumer electronic device brand selection, the command sets corresponding with the second brand can be given a higher probability than those corresponding to the third brand. In an example, where multiple of command sets have the same probability, this subset can be ordered or unordered. To order the subset, additional ordering criteria can be based on probabilistic ordering, or some other differentiating characteristics.

Using probabilistic ordering increases the chances that the nest command set tested is the correct one. This can be accomplished without adding additional control elements to a handheld remote control device. It can also be accomplished with relatively simple user interfaces. Further, probabilistic ordering can be adaptive in ways that manipulating the user interface alone cannot. Thus, a user can more easily and quickly program a handheld remote control device while manufactures of these devices can maintain good design principles and reduce costs.

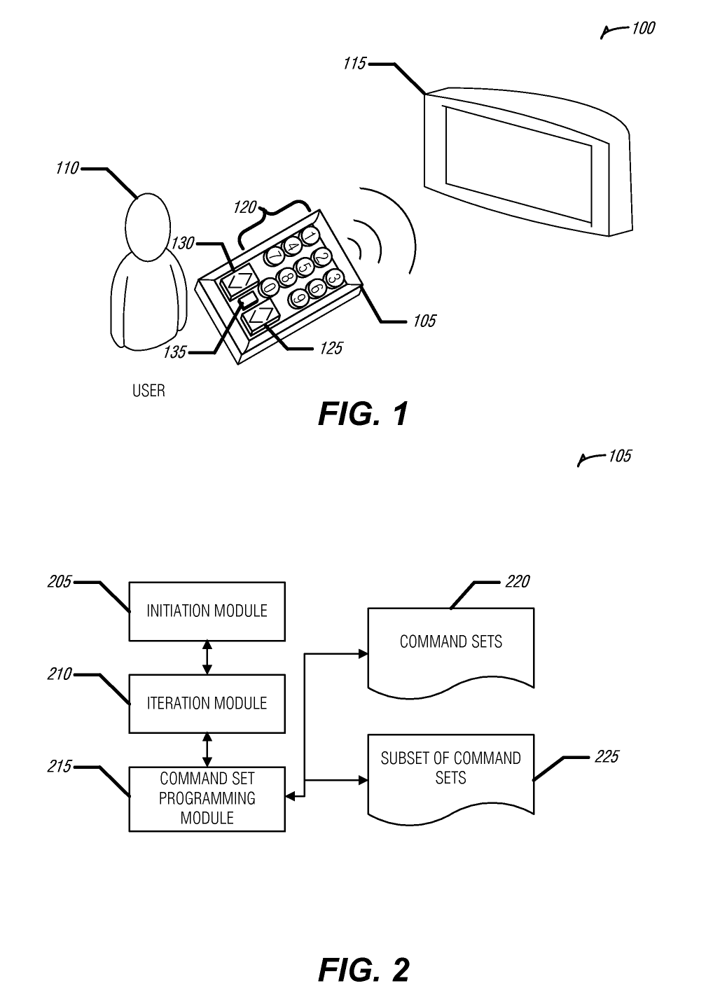

FIG. 1 illustrates an example of a system 100 for command set selection in a handheld remote control device 105. The system 100 can include the handheld remote control device 105 (e.g., operated by a user 110) and a consumer electronic device 115. The handheld remote control device 105 can include a numeric keypad 120, a multi-directional volume control 130, a multi-directional channel control 125, and a programming button 135 control elements. The system 100 illustrates a common handheld remote control device 105 programming scenario. Namely, the user 100 manipulates the handheld remote control device 105—for example, by actuating any of the control elements 120, 125, 130, or 135—during the programming. Commands are sent from the handheld remote control device 105 to the consumer electronic device 115. The effect of sending these commands can be observed to determine whether a command set corresponding to the commands corresponds to the consumer electronic device 115.

Handheld remote control devices can be one of mechanically active, mechanically passive, or a hybrid. A mechanically active handheld remote control device has only control elements that include mechanical movement in their actuation. Such control elements can include keys (e.g., buttons), dials, switches, etc. A mechanically active handheld remote control device can include, or be free of, a display. However, the control elements all include mechanical movement.

A mechanically passive handheld remote control device has only control elements that do not include mechanical movement in their actuation. Such control elements can include touchscreen displays, or touch sensitive pads, gesture enabling positioning sensors, etc. Although there can be some movement, as perceived by the user 110, the control element itself is not moving. Thus, although a gesture based control can involve the pitching and rolling of the handheld remote control device housing, no control element appears to be moving with respect to that housing.

A hybrid handheld remote control device can include any type of control element. Accordingly, a hybrid handheld remote control device can include both a touch screen control element and a button control element.

FIG. 2 illustrates an example of components for command set selection in a handheld remote control device 105. The handheld remote control device 105 can include an initiation module 205, an iteration module 210, and a command set programming module 215. The handheld remote control device 105 can also include access to a set of command sets 220 and a subset of command sets 225. In an example, this access is exclusively local (e.g., contained within the handheld remote control device 105). In an example, the access can include communicating with a repository over a network. In an example, access to the subset of command sets 225 exists if the subset of command sets 225 exists and is accessible or if the subset of command sets 225 can be created and then accessed. In an example, commands that are part of members of the set of command sets 220 can include an infrared (IR) sequence.

In an example, the set of command sets 220 can include, or can correspond to, a plurality of probability metrics. For example, as noted above, the probability that the consumer electronic device 115 is responsive to a given command set can be based on sales figures. The probability can also be based on consumer surveys. Because these probabilities can differ, different corresponding probability metrics can be used by the handheld remote control device 105 to differentiate between them when performing probabilistic ordering. Additionally, because the probability metrics are smaller than the entire set of command sets 220, the probability metrics can be updated more efficiently than providing a new set of command sets 220 to traditionally limited capability handheld remote control devices 105

The initiation module 205 can be arranged to receive an initiation input for programming the handheld remote control device 105. In an example, the initiation module 205 can be arranged to receive an indication that the user 110 has activated a physical programming initiation control. In an example, the physical programming initiation control can include a button (e.g., the programming button 135). For example, the user 110 can actuate the programming button 135 to send the initiation input. The initiation input can be generated from any physical control element actuation, including a time-measured actuation (e.g., holding a button down for a period of time). In an example, the physical initiation control can include a plurality of buttons, or other control elements. For example, a sequence of numbers from the keypad 120, simultaneously actuating the volume button 130 down and the “0” key from the keypad 120, etc.

The iteration module 210 can be arranged to iterate over the subset of command sets 225. The iteration module 210 can be arranged to iterate in response to the receipt of the initiation input. The subset of command sets 225 can be selected from the command sets 220 using probabilistic ordering. In an example, the probability underlying the probabilistic ordering is the probability that the consumer electronic device 115 is responsive to a member of the subset of command sets 225. In an example, the iteration module 210 is arranged to perform the probabilistic ordering to select the subset of command sets 225.

For each iteration, the iteration module 210 can be arranged to select a next command set from the subset of command sets 225 to be a current command set and to test the current command set. In an example, to select the next command set, the iteration module 210 can be arranged to use the probabilistic ordering. In an example, the iteration module 210 can be arranged to use a different probabilistic ordering to select the next command set. In an example, using probabilistic ordering, the iteration module 210 can be arranged to select a command set with an equal-to-or-higher likelihood that the consumer electronic device 115 is responsive to the command set that to unselected members of the subset of command sets 225. Thus, each new selection of the next command set is the most likely to be correct for the consumer electronic device 115.

In an example, the iteration module 210 can be arranged to automatically test the current command set. For example, the iteration module 210 can cause a command from the current command set to be transmitted to the consumer electronic device 115. In an example, the iteration module 210 can be arranged to accept input from the user 110 to test a default command. For example, the default command can be power-on. The iteration module 210 can be arranged to note any control element actuation and transmit the power-on command to the consumer electronic device 115. In an example, the iteration module 210 can be arranged to accept inform from the user 110 corresponding to a particular command from the current command set and to send that particular command to the consumer electronic device 115.

The iteration module 210 can be arranged to terminate the iterative process in response to a command set confirmation input (e.g., received directly or by the command set programming module 215). Otherwise, the iteration module 210 is arranged to continue iterating until a termination condition, such as reaching the end of the subset of sets 225. In an example, the iteration module 210 can be arranged to move from one iteration to the next in response to the user 110 actuating a control element. For example, the control element can be the channel control 125 which the user 110 actuates by pressing “up” to move to the next iteration. In an example, the iteration module 210 can be arranged to automatically progress from one iteration to the next. For example, the iteration module 210 can be arranged to wait for a time period (e.g., five seconds) and then move on to the next iteration. In an example, the automatic progression can be in response to an indication that the command set test failed.

The command set programming module 215 can be arranged to receive the command set confirmation input. In an example, the command set programming module 215 can be arranged to receive an indication that the user 110 has actuated (e.g., activated) the physical programming selection control (e.g., the button 135). Thus, the user 110 indicates that the current command set test was successful (e.g., by observing a change in the consumer electronic device 115).

In an example, the command set programming module 215 can be arranged to receive an indication from a sensor of the handheld remote control device 105 in response to an observable effect of the consumer electronic device 115. In this example, the observable effect occurs in response to the test and is observable with respect to the sensor. For example, for an audio threshold sensor, the observable effect can include the sound of a television program after the television 115 is turned on due to the testing. Other observable effects can include electromagnetic emissions (e.g., light, magnetic variations), vibrations, etc., depending on available sensors in the handheld remote control device 105.

In an example, the command set programming module 215 can be arranged to receive an indication from the consumer electronic device 115 in response to the test of the current command set. In this example, the indication originates from the consumer electronic device 115 and is purposefully directed toward the handheld remote control device 105. In contrast, an undirected observable effect, such as sound from a radio, is not purposefully directed toward the handheld remote control device 105. Purposeful direction can include addressing the indication to the handheld remote control device 105.

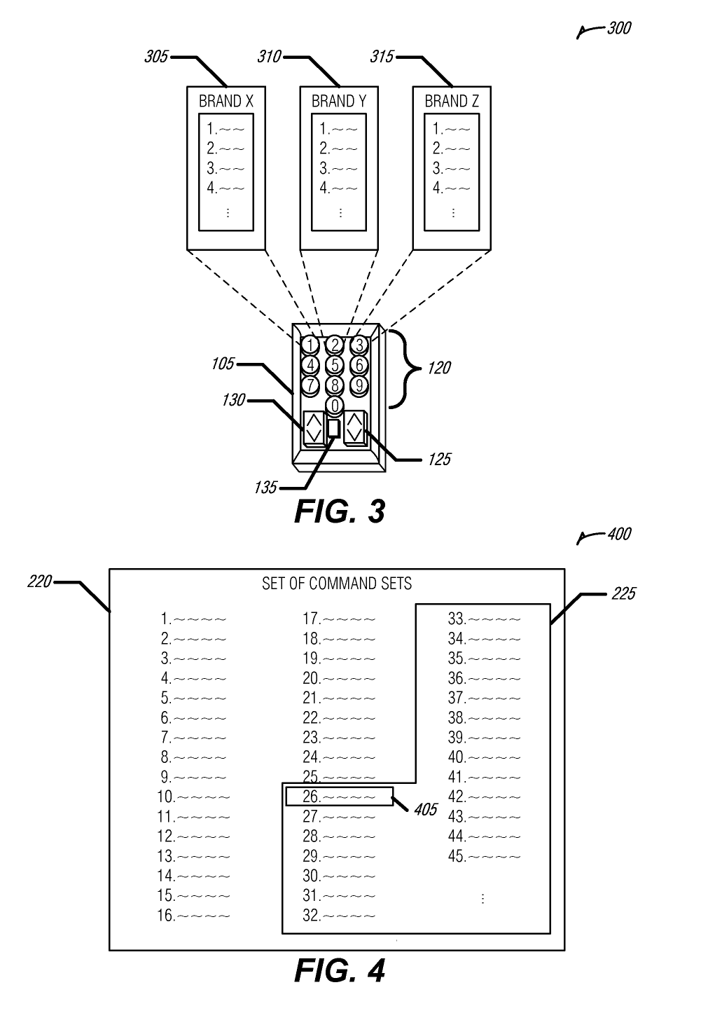

FIGS. 3 and 4 illustrate examples 300 and 400 of command set selection with probabilistic ordering. The example 300 illustrates a probabilistic ordering based on consumer electronic device brand. In example 300, the subset of command sets 225 can correspond to a brand, such as Brand X 305, Brand Y 310, or Brand Z 315. In an example, the probabilistic ordering can be based on sales figures for the brands. For example, the subset of command sets 225 chosen first can correspond to Brand X 305 because Brand X 305 had more sales than the other brands. In an example, other bases of brand popularity can be used, such as consumer surveys, production, etc.

In an example, the initiation module 205 can be arranged to receive a brand indication from the user 110. In an example, the initiation module 205 can be arranged to assign a plurality of consumer electronic device brands to respective control elements (e.g., keys) 120) of the handheld remote control device 105. For example, Brand X 305 is assigned to the “1” key, Brand Y 310 is assigned to the “2” key, and Brand Z 315 is assigned to the “3” key. In an example, the initiation module can be arranged to designate a subset of control elements to be available for assignment. For example, although the handheld remote control device 105 has control elements other than the keys 120, brand assignment can be limited to the keys 120. In an example, the brand assignments to the subset of control elements can be updated. For example, if there are more than ten brands, but the cardinality of the subset of control elements is ten, a first ten brands can be respectively assigned to the members of the subset of control elements. Actuation of a control element can be detected to replace the first brand assignments with second brand assignments. For example, if the volume control 130 is used to control the iteration, the channel control 125 can be used to update the brand assignments. Thus, if the user 110 exhausts the brands in the first assignments, the user 110 can actuate the volume control (e.g., pressing “up”) to get a second set of brand to key assignments. Although the channel control 125 is described above as the re-assignment input, any dedicated control element can be used, including a control element with variable actuation (e.g., long hold, sequence of presses, etc.). is assigned to the “2” key, and Brand Z is assigned to the “3” key. In an example, the initiation module 205 can be arranged to select the brand in response to receiving a notification that a key corresponding to the brand was actuated. For example, if the user 110 presses the “2” key, the initiation module 205 can select Brand Y 310. As noted above, this input can be used to adapt the probabilistic ordering for the subset of command sets 225. For example, a user's 110 choice of Brand X 305 can be used to select a first subset of the command set 225. However, the correct command set is not in this subset. It is known that Brand Z 315 is less popular than Brand Y 310. It is also known that consumers confuse Brand X 305 and Brand Z 315. Thus, Brand Z 315 can be selected for the subset of command sets 225 in spite of its lower popularity because the user's 110 mistaken choice of Brand X 305 indicates that Brand Z 315 is more likely than Brand Y 310.

In an example, where a manual transition is in place for the iteration, the key assigned to a brand can be used to transition from one iteration to another. For example, if key “1” is assigned to Brand X 305, and the user 110 actuates key “1”, a first command set for Brand X 305 can be tested. If this test fails, the user 101 can select key “1” again to transition to the next iteration and test the next command set for Brand X 305. In an example, the Brand X 305 key (e.g., key “1”) can be used for manual transitions of other brands. For example, as discussed above, Brand Z 315 may be the next likely candidate brand for a user 110 that had previously selected Brand X 305. In this scenario, the user 110 can continue pressing the “1” key to cycle through the command sets corresponding to Brand Z 315.

In an example, the brand to key assignment can be based on the popularity of the brand and key accessibility metrics of the keys. For example, more popular brands can be assigned to more accessible keys. In an example, brand popularity can be based on brand market share, or other market factors. Key accessibility metrics can include both the ease with which the user 110 can actuate a key and also the likely behavior of the user 110. For example, the user 110 may be conditioned to press the “1” key first even if the “0” key is easier to access. In this scenario, the “1” key would have a higher accessibility metric. Matching the accessibility metric with the brand popularity increases the likelihood that the user 110 selects a more popular brand earlier in the process and thus is more likely to find the correct command set early as well.

In the example 400, the initiation input can include a brand code or a consumer electronic device code. For example, the user 110 can use the keypad 120 to enter a two digit consumer electronic device code (e.g., from a manual). In the example 400, the set of command sets 220 can be ordered. The entered code (e.g., “26”) corresponds to positional member 405 of (e.g., an entry in) the set of command sets 220. The positional member 405 defines a point within the subset set of command sets 220 from which to determine the subset of command sets 225. In the example 400, the positional member 405 corresponds to the first member of the subset of command sets 225 and the last member of the set of command sets 220 corresponds to the last member of the subset of command sets 225. In an example, the subset of command sets 225 also includes members of the ordered set of commands 220 between the positional member 405 and one or two additional members. For example, the subset of command sets 225 can include the positional member 405 as the first member and all other command sets between the positional member 405 and a predetermined position (e.g., additional member such as the last command set) of the ordered set of command sets.

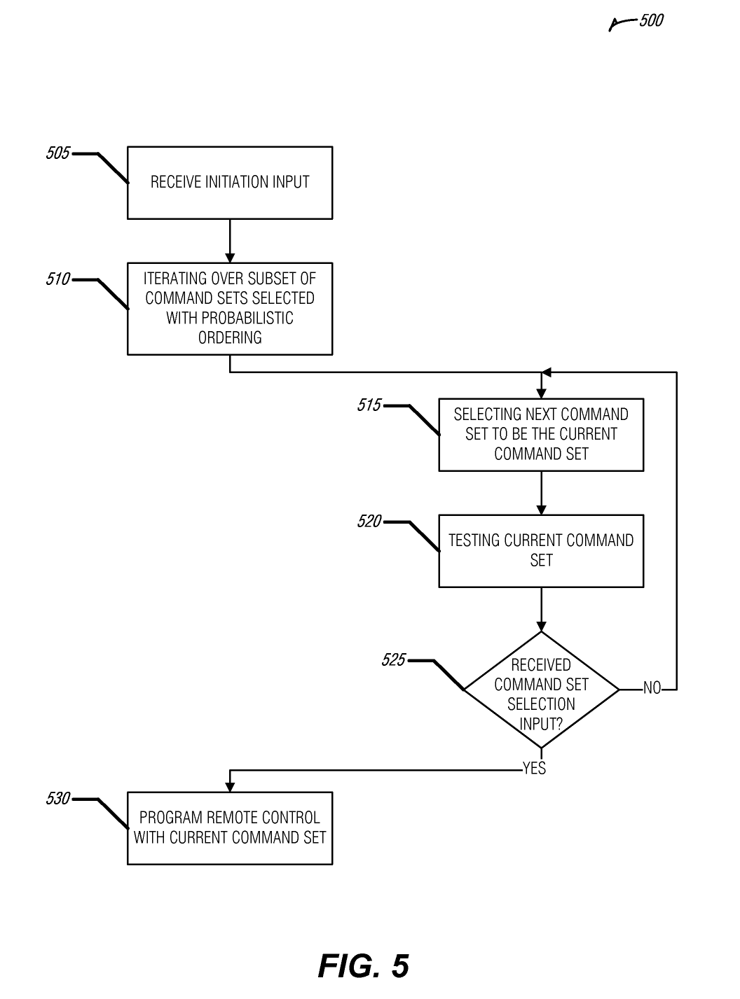

FIG. 5 illustrates an example of a method 500 for command set selection in a handheld remote control. Any one or more of the operations of the method 500 can be performed by one or more previously discussed components of FIGS. 1-4, or other hardware capable of performing the operations.

At operation 505, an initiation input for programming the handheld remote control device can be received. In an example, receiving the initiation input can include receiving an indication that the handheld remote control's user has activated a physical programming initiation control. The activation or physical programming control can be any of those discussed above. In an example, the physical programming initiation control can include a button (e.g., a programming button). In an example, the physical programming initiation can include a plurality of buttons (e.g., simultaneous actuation of a plurality of buttons, actuation of a sequences of buttons, etc.).

At operation 510, a subset of command sets can be iterated over. The subset of command sets can be selected with probabilistic ordering. Members of the subset of command sets include a plurality of commands to control a consumer electronic device. In an example, the commands of the members can include an infrared (IR) sequence. Probabilistic ordering, as discussed above, can be based on a probability that the consumer electronic device is responsive to a member of the subset of command sets.

In an example, the probabilistic ordering can be based on brands. That is, the subset of command sets can correspond to one or more particular consumer electronic device brands. For example, Brand X may be the most popular brand in the user's area based on sales. Thus, Brand X can be considered the most popular. However, in the case where Brand Y lasts significantly longer than Brand X, Brand Y may be more prevalent in user's locations. Brand based selection can also include selecting a second brand based on user selection of a first brand. For example, let Brand X be the most popular, Brand Y the second, and Brand Z the least popular brand. However, consumer testing has shown that users are more likely to confuse Brand Z with Brand X than with Brand Y. The user provides a selection of Brand X. After exhausting the command sets that are compatible with Brand X, the probabilistic ordering can select Brand Z over Brand Y for another iterative target based on the likelihood that the user confused Brand X with Brand Z.

In an example the user can select a brand (e.g., an initial brand). In an example, the selection can include, assigning a plurality of consumer electronic device brands to respective keys of the handheld remote control device. The actual assignments can be based on a probability that the consumer electronic device corresponds to a brand in the plurality of brands and key accessibility metrics. For example, if the “1” key is determined to be easy, or likely, for a user to press first, the most popular brand can be assigned to the “1” key. Thus, the key accessibility metrics can be used to predict what keys, or sequence of keys, the user will likely access, and assigns more popular brands to those keys. The brand can be selected in response to receiving a notification that a key corresponding to the brand was activated. For example, if Brand Y was assigned to key “2,” then the handheld remote control device will receive a notification (e.g., interrupt, message, etc.) upon activation of the “2” button. At this juncture, the handheld remote control device can select Brand Y based on the previous assignment.

In an example, the initiation input can include either a brand code for a brand of consumer electronic devices or a device code for the consumer electronic device. In an example, the subset of command codes can be selected based on this initiation input. In an example, the subset of command sets can be selected from an ordered set of command sets. A positional member (e.g., first member, last member, median member, etc.) of the subset of command sets can correspond to the brand code or the device code. For example, if it is a brand code, a command set corresponding to the brand can be selected. In an example, the subset of command sets also includes members of the ordered set of commands between the positional member and one or two additional members. For example, the subset of command sets can include the positional member as the first member and all other command sets between the position member and a predetermined position (e.g., additional member such as the last command set) of the ordered set of command sets.

In an example, transitioning between iterations can be automatic. For example, a current iteration can be terminated in favor of a next iteration after a pre-determined time period. In an example, the iteration transition can be manual. In an example, a manual iteration can occur in response to received indication from the user. For example, the iterating can proceed in response to the user pushing the “1” button. In an example, the indication can include a direction. For example, the user can actuate the down-channel button (or the like, e.g., down-volume button) to move in a first direction and the up-channel button to move in the opposite direct. Operations 515 and 520 describe an example of a single iteration performed during the iterating.

At operation 515, a next command set can be selected from the subset of command sets to be a current command set. For example, in the initial condition—e.g., before any particular command set has been considered during the iteration—a first command set is selected and set to be the current command set. In following iterations, the current command set is replaced with a new selection from the subset of command sets. In an example, selecting the next command set can include using the probabilistic ordering to select a command set with an equal-to-or-higher likelihood that the consumer electronic device is responsive to it over unselected members of the subset of command sets. For example, if half of the members of the subset of command sets have already been selected, the next command set will be selected from the remaining (e.g., previously unselected) members. This selection will order these members within the subset of command sets based on a probabilistic ordering. In an example, this member based ordering is different than the probabilistic ordering user to select the subset of the command sets.

At operation 520, the current command set can be tested. In an example, testing the current command set can include transmitting a command from the handheld remote control device to the consumer electronic device. In an example, the command can be transmitted automatically (e.g., without user intervention). For example, when the current iteration is reached, the power-on command from the newly selected current command set can be transmitted to the consumer electronic device without additional user input or interaction. In an example, the command can be transmitted in response to a user input. For example, after the new current command set is selected, the user can actuate the power-on button. Upon receipt of the indication that the power-on button was actuated, the command can be sent to the consumer electronic device.

At operation 525, a command set confirmation input can be received. If the command set confirmation is not received, the iteration continues with operation 515. Otherwise, the iteration terminates. In an example, receiving the command set confirmation input can include receiving an indication that a user of the handheld remote control device has activated a physical programming selection control. For example, if the handheld remote control device has a specific “programming button,” the user can actuate this button to produce the command set confirmation.

In an example, receiving the command set confirmation input can include receiving an indication from a sensor of the handheld remote control device. The sensor can be configured to detect an observable effect from the consumer electronic device in response to the testing of the current command set. For example, the handheld remote control device can include a microphone and a decibel monitor. If the room is silent, and the test performs a power-on command, the sensor can detect sound produced by the consumer electronic device in response to turning on. In an example, the consumer electronic device can transmit confirmation of the current command set (e.g., successful testing of the current command set) directly to the handheld remote control device. For example, the consumer electronic device can receive the power-on command and transmit an electro-magnetic communication. In an example, the communication indicates a general change in state (e.g., the consumer electronic device has recently turned on). In an example, the communication can indicate that the received command corresponds to a command set that is compatible with the consumer electronic device.

At operation 530, as the iteration terminates from operation 525 in response to receiving the command set confirmation, the handheld remote control device can be programmed with the current command set. At this stage, the current command set corresponds to the last command set tested.

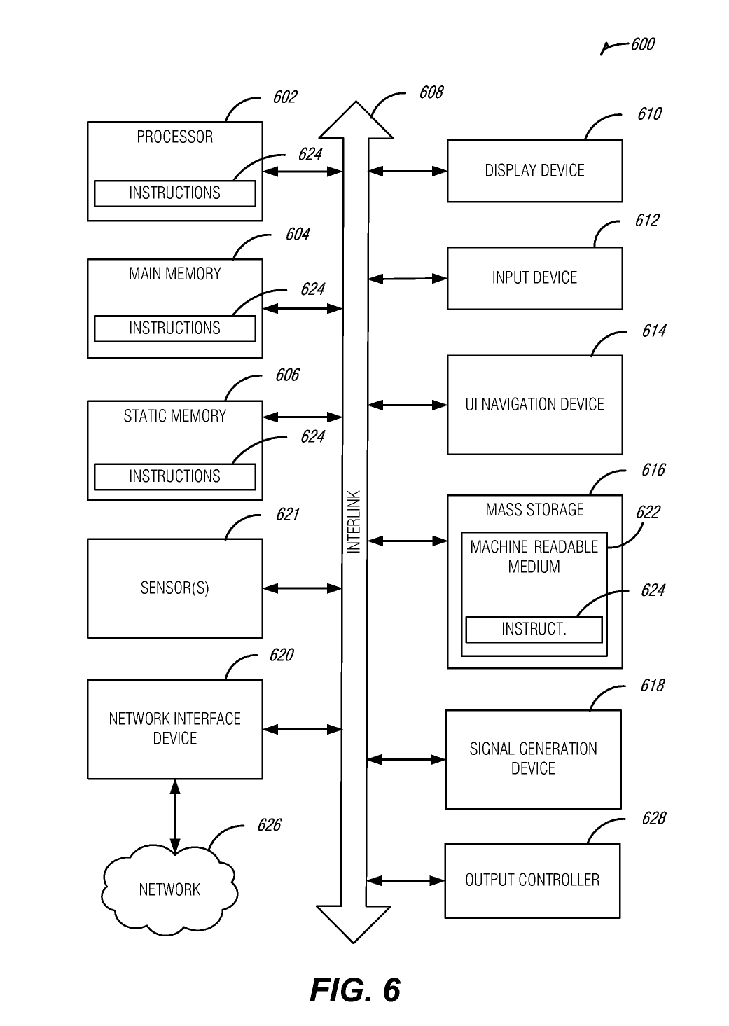

FIG. 6 illustrates a block diagram of an example machine 600 upon which any one or more of the techniques (e.g., methodologies) discussed herein may perform or which may implement or support the handheld remote control device. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in a peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Although only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, modules (e.g., logic or a number of components, mechanisms, or other hardware elements). Modules are hardware capable of performing specified operations. For example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module to perform specified operations. In an example, the software may reside on a machine readable medium. In an example, the software, when executed by the underlying hardware of the module, causes the hardware to perform the specified operations. Thus, although software can be used to configure the module, the module is itself hardware.

Modules can be permanently configured (e.g., hardwired), or temporarily configured (e.g., by programming programmable hardware that can be reverted to its original state) to perform part or all of any operation described herein. Considering examples in which modules are temporarily configured, each of the modules need not be instantiated at any one moment in time. For example, where a module comprises a general-purpose hardware processor configured by software, the general-purpose hardware processor may be configured to be different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., IR, near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. A massed machine readable medium is not a signal itself, but can be arranged to bear a signal. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Additional Notes & Examples

Example 1 includes subject matter (such as a device, apparatus, or a handheld remote control device) comprising an initiation module arranged to receive an initiation input for programming the handheld remote control device, an iteration module arranged to iterate—in response to the initiation input—over a subset of command sets selected with probabilistic ordering—members of the subset of command sets including a plurality of commands to remotely control a consumer electronic device, the probabilistic ordering based on a probability that the consumer electronic device is responsive to a member of the subset of command sets—wherein to iterate—the iteration module is arranged to select a next command set from the subset of command sets to be a current command set, test the current command set, and terminate in response to a command set confirmation input. The subject matter of Example 1 can also include a command set programming module arranged to receive the command set confirmation input, and program the handheld remote control device with the current command set in response to the command set confirmation input.

In Example 2, the subject matter of Example 1 can optionally include, wherein to receive the initiation input includes the initiation module arranged to receive an indication that a user of the handheld remote control device has activated a physical programming initiation control.

In Example 3, the subject matter of Example 2 can optionally include, wherein the physical programming initiation control includes a button.

In Example 4, the subject matter of any of Examples 2-3 can optionally include, wherein the physical programming initiation control includes a plurality of buttons.

In Example 5, the subject matter of any of Examples 1-4 can optionally include, wherein to receive the command set confirmation input includes the command set programming module arranged to receive an indication that a user of the handheld remote control device has activated a physical programming selection control.

In Example 6, the subject matter of any of Examples 1-5 can optionally include, wherein to receive the command set confirmation input includes the command set programming module arranged to receive an indication from a sensor of the handheld remote control device in response to an observable effect of the consumer electronic device—the observable effect occurring in response to the testing of the current command set.

In Example 7, the subject matter of any of Examples 1-6 can optionally include, wherein to receive the command set confirmation input includes the command set programming module arranged to receive an indication from the consumer electronic device in response to the testing of the current command set.

In Example 8, the subject matter of any of Examples 1-7 can optionally include, wherein the subset of command sets corresponds to a brand of consumer electric devices.

In Example 9, the subject matter of Example 8 can optionally include, wherein the probabilistic ordering is based on sales figures for the brand.

In Example 10, the subject matter of any of Examples 8-9 can optionally include, wherein the initiation module is arranged to assign a plurality of consumer electric device brands to respective keys of the handheld remote control device—the assignment based on a probability that the consumer electronic device corresponds to a brand in the plurality of brands and key accessibility metrics respectively corresponding to keys in the plurality of keys, and select the brand in response to receiving a notification that a key corresponding to the brand was activated.

In Example 11, the subject matter of any of Examples 1-10 can optionally include, wherein the initiation input includes either a brand code for a brand of consumer electronic devices or a device code for a consumer electronic device, and wherein the subset of command sets is selected from an ordered set of command sets, the first member of the subset of command sets corresponding to the brand code or the device code—the subset of command sets also including members of the ordered set of commands between the first member and a predetermined position of the ordered set of command sets.

In Example 12, the subject matter of any of Examples 1-10 can optionally include, wherein to select the next command set includes the iteration module arranged to use the probabilistic ordering to select a command set with an equal-to-or-higher likelihood that the consumer electronic device is responsive to it than unselected members of the subset of command sets.

In Example 13, the subject matter of any of Examples 1-10 can optionally include, wherein the commands include an infrared (IR) sequence.

Example 14 can include, or can optionally be combined with the subject matter of any of Examples 1-13 to include, subject matter (such as a method, means for performing acts, or machine readable medium including instructions that, when performed by a machine cause the machine to performs acts) comprising receiving an initiation input for programming the handheld remote control device, iterating—in response to the initiation input—over a subset of command sets selected with probabilistic ordering—members of the subset of command sets including a plurality of commands to remotely control a consumer electronic device—the probabilistic ordering based on a probability that the consumer electronic device is responsive to a member of the subset of command sets—the iterating including selecting a next command set from the subset of command sets to be a current command set and testing the current command set, receiving a command set confirmation input, and terminating the iterating and programming the handheld remote control device with the current command set in response to the command set confirmation input.

In Example 15, the subject matter of Example 14 can optionally include, wherein receiving the initiation input includes receiving an indication that a user of the handheld remote control device has activated a physical programming initiation control.

In Example 16, the subject matter of Example 15 can optionally include, wherein the physical programming initiation control includes a button.

In Example 17, the subject matter of any of Examples 15-16 can optionally include, wherein the physical programming initiation control includes a plurality of buttons.

In Example 18, the subject matter of any of Examples 14-17 can optionally include, wherein receiving the command set confirmation input includes receiving an indication that a user of the handheld remote control device has activated a physical programming selection control.

In Example 19, the subject matter of any of Examples 14-18 can optionally include, wherein receiving the command set confirmation input includes receiving an indication from a sensor of the handheld remote control device in response to an observable effect of the consumer electronic device—the observable effect occurring in response to the testing of the current command set.

In Example 20, the subject matter of any of Examples 14-19, wherein receiving the command set confirmation input includes receiving an indication from the consumer electronic device in response to the testing of the current command set.

In Example 21, the subject matter of any of Examples 14-20 can optionally include, wherein the subset of command sets corresponds to a brand of consumer electric devices.

In Example 22, the subject matter of Example 21 can optionally include, wherein the probabilistic ordering is based on sales figures for the brand.

In Example 23, the subject matter of any of Examples 21-22 can optionally include, wherein the operations include assigning a plurality of consumer electric device brands to respective keys of the handheld remote control device—the assigning based on a probability that the consumer electronic device corresponds to a brand in the plurality of brands and key accessibility metrics respectively corresponding to keys in the plurality of keys, and selecting the brand in response to receiving a notification that a key corresponding to the brand was activated.

In Example 24, the subject matter of any of Examples 14-23 can optionally include, wherein the initiation input includes either a brand code for a brand of consumer electronic devices or a device code for a consumer electronic device, and wherein the subset of command sets is selected from an ordered set of command sets, the first member of the subset of command sets corresponding to the brand code or the device code—the subset of command sets also including members of the ordered set of commands between the first member and a predetermined position of the ordered set of command sets.

In Example 25, the subject matter of any of Examples 14-23 can optionally include, wherein selecting the next command set includes using the probabilistic ordering to select a command set with an equal-to-or-higher likelihood that the consumer electronic device is responsive to it than unselected members of the subset of command sets.

In Example 26, the subject matter of any of Examples 14-23 can optionally include, wherein the commands include an infrared (IR) sequence.

The above detailed description includes references to the accompanying drawings, which form a part of the detailed description. The drawings show, by way of illustration, specific embodiments that may be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is to allow the reader to quickly ascertain the nature of the technical disclosure and it is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A handheld remote control device comprising:
an initiation module arranged to receive an initiation input for programming the handheld remote control device;
an iteration module arranged to iterate, in response to the initiation input, over a subset of command sets selected with probabilistic ordering, members of the subset of command sets including a plurality of commands to remotely control a consumer electronic device, the probabilistic ordering based on a probability that the consumer electronic device is responsive to a member of the subset of command sets, wherein to iterate, the iteration module is arranged to:
select a next command set from the subset of command sets to be a current command set;
test the current command set; and
terminate in response to a command set confirmation input; and
a command set programming module arranged to:
receive the command set confirmation input; and
program the handheld remote control device with the current command set in response to the command set confirmation input.

2. The device of claim 1, wherein to receive the initiation input includes the initiation module arranged to receive an indication that a user of the handheld remote control device has activated a physical programming initiation control.

3. The device of claim 2, wherein the physical programming initiation control includes a button.

4. The device of claim 2, wherein the physical programming initiation control includes a plurality of buttons.

5. The device of claim 1, wherein the subset of command sets corresponds to a brand of consumer electric devices.

6. The device of claim 5, wherein the initiation module is arranged to:
assign a plurality of consumer electric device brands to respective keys of the handheld remote control device, the assignment based on a probability that the consumer electronic device corresponds to a brand in the plurality of brands and key accessibility metrics respectively corresponding to keys in the plurality of keys; and
select the brand in response to receiving a notification that a key corresponding to the brand was activated.

7. The device of claim 1, wherein the initiation input includes either a brand code for a brand of consumer electronic devices or a device code for a consumer electronic device, and wherein the subset of command sets is selected from an ordered set of command sets, the first member of the subset of command sets corresponding to the brand code or the device code, the subset of command sets also including members of the ordered set of commands between the first member and a predetermined position of the ordered set of command sets.

8. A massed machine-readable medium including instructions that, when executed by a handheld remote control device, cause the handheld remote control device to perform operations comprising:
receiving an initiation input for programming the handheld remote control device;
iterating, in response to the initiation input, over a subset of command sets selected with probabilistic ordering, members of the subset of command sets including a plurality of commands to remotely control a consumer electronic device, the probabilistic ordering based on a probability that the consumer electronic device is responsive to a member of the subset of command sets, the iterating including:
selecting a next command set from the subset of command sets to be a current command set; and
testing the current command set;
receiving a command set confirmation input; and
terminating the iterating and programming the handheld remote control device with the current command set in response to the command set confirmation input.

9. The machine-readable medium 8, wherein receiving the command set confirmation input includes receiving an indication from a sensor of the handheld remote control device in response to an observable effect of the consumer electronic device, the observable effect occurring in response to the testing of the current command set.

10. The machine-readable medium of claim 8, wherein receiving the command set confirmation input includes receiving an indication from the consumer electronic device in response to the testing of the current command set.

11. The machine-readable medium of claim 8, wherein the subset of command sets corresponds to a brand of consumer electric devices.

12. The machine-readable medium of claim 11, wherein the probabilistic ordering is based on sales figures for the brand.

13. The machine-readable medium of claim 11, wherein the operations include:
assigning a plurality of consumer electric device brands to respective keys of the handheld remote control device, the assigning based on a probability that the consumer electronic device corresponds to a brand in the plurality of brands and key accessibility metrics respectively corresponding to keys in the plurality of keys; and
selecting the brand in response to receiving a notification that a key corresponding to the brand was activated.

14. The machine-readable medium of claim 8, wherein the initiation input includes either a brand code for a brand of consumer electronic devices or a device code for a consumer electronic device, and wherein the subset of command sets is selected from an ordered set of command sets, the first member of the subset of command sets corresponding to the brand code or the device code, the subset of command sets also including members of the ordered set of commands between the first member and a predetermined position of the ordered set of command sets.

15. The machine-readable medium of claim 8, wherein selecting the next command set includes using the probabilistic ordering to select a command set with an equal-to-or-higher likelihood that the consumer electronic device is responsive to it than unselected members of the subset of command sets.

16. A method performed by hardware of a handheld remote control device, the method comprising:
receiving an initiation input for programming the handheld remote control device;
iterating, in response to the initiation input, over a subset of command sets selected with probabilistic ordering, members of the subset of command sets including a plurality of commands to remotely control a consumer electronic device, the probabilistic ordering based on a probability that the consumer electronic device is responsive to a member of the subset of command sets, the iterating including:
selecting a next command set from the subset of command sets to be a current command set; and
testing the current command set;
receiving a command set confirmation input; and
terminating the iterating and programming the handheld remote control device with the current command set in response to the command set confirmation input.

17. The method of claim 16, wherein the subset of command sets corresponds to a brand of consumer electric devices.

18. The method of claim 17 including:
assigning a plurality of consumer electric device brands to respective keys of the handheld remote control device, the assigning based on a probability that the consumer electronic device corresponds to a brand in the plurality of brands and key accessibility metrics respectively corresponding to keys in the plurality of keys; and
selecting the brand in response to receiving a notification that a key corresponding to the brand was activated.

19. The method of claim 16, wherein the initiation input includes either a brand code for a brand of consumer electronic devices or a device code for a consumer electronic device, and wherein the subset of command sets is selected from an ordered set of command sets, the first member of the subset of command sets corresponding to the brand code or the device code, the subset of command sets also including members of the ordered set of commands between the first member and a predetermined position of the ordered set of command sets.

20. The method of claim 16, wherein the commands include an infrared (IR) sequence.
